(19) United States
(12) Patent Application Publication
(10) Pub. No.: US 2024/0259770 A1
(43) Pub. Date: Aug. 1, 2024

(54) MOBILE RADIO DEVICE WITH CONFERENCING CAPABILITY

(71) Applicant: WEAVIX, INC., Wichita, KS (US)

(72) Inventors: Kevin TURPIN, Wichita, KS (US); Benjamin BURRUS, Wichita, KS (US)

(21) Appl. No.: 18/418,761

(22) Filed: Jan. 22, 2024

Related U.S. Application Data
(60) Provisional application No. 63/481,756, filed on Jan. 26, 2023.

(51) Int. Cl. H04W 4/10; H04N 7/15

(52) U.S. Cl. CPC H04W 4/10; H04N 7/15

(57) ABSTRACT

This document discloses a mobile radio device with conferencing capabilities. The mobile radio device can connect to a conferencing session. The mobile radio device can include a Push-to-Talk (PTT) button that controls the transmission or reception of data to or from other devices connected to the video conferencing session. For example, audio data collected by the mobile radio device while the PTT button is pressed can be transmitted to other devices connected to the video conferencing session and output by speakers at these devices. When the PTT button is released, the mobile radio device can be muted in the video conferencing session. In general, the mobile radio device can enable a worker to participate in a conference (e.g., conference call, video conference) while in the field. In doing so, worker accessibility may be improved, which can limit safety concerns and increase productivity.

### CROSS-REFERENCE TO RELATED APPLICATIONS

This application claims the benefit of U.S. Provisional Patent Application No. 63/481,756, filed Jan. 26, 2023, which is incorporated by reference herein in its entirety.

### TECHNICAL FIELD

The present disclosure is generally related to wireless communication handsets and systems.

### BACKGROUND

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in-field, difficult to use in a dirty environment or when wearing protective equipment, or overly bulky for daily transportation on site. Accordingly, workers may be less accessible to their teams, which can lead to safety concerns and a decrease in productivity.

### BRIEF DESCRIPTION OF THE DRAWINGS

FIG. 1 is a block diagram illustrating an example architecture for an apparatus with conferencing capability, in accordance with one or more embodiments.

FIG. 2 is a drawing illustrating an example environment for apparatuses and communication networks with conferencing capability, in accordance with one or more embodiments.

FIG. 3 is a drawing illustrating an example facility using apparatuses and communication networks with conferencing capability, in accordance with one or more embodiments.

FIG. 4 is a block diagram illustrating an example machine learning (ML) system, in accordance with one or more embodiments.

FIG. 5 is a block diagram illustrating an example computer system, in accordance with one or more embodiments.

FIG. 6 illustrates a method for conferencing with a mobile radio device, in accordance with one or more embodiments.

FIG. 7 illustrates an example mobile radio device with conferencing capability, in accordance with one or more embodiments.

### DETAILED DESCRIPTION

Construction, manufacturing, repair, utility, resource extraction and generation, and healthcare industries, among others, utilize radios to communicate with workers performing in-field tasks. Often, radios lack communication capabilities, such as conferencing, that are available to workers on other electronic devices. Thus, workers may be forced to carry other, less usable or less durable devices in the field. Even with these other devices, however, workers joining meetings from the worksite can disrupt the meeting for themselves or other attendees due to the high levels of background noise at the worksite. Accordingly, workers may be forced to leave worksites to communicate with their team. The present technology includes a mobile radio device capable of joining conferences (e.g., conference calls, video conferences) from the field. The disclosed mobile radio device provides a single, user-friendly, comfortable, and cost-effective device that eliminates the need for workers to wear multiple, cumbersome, non-integrated, and potentially distractive devices. Advantages of the disclosed mobile radio device include a greater ease of use for carrying in the field during extended durations and device capabilities tailored to in-field conditions. Moreover, the modular design of the disclosed mobile radio device enables quick repair, refurbishment, or replacement.

The mobile radio device disclosed herein can be capable of communicating using Radio over Internet Protocol (RoIP) and provide the ability to use an existing Land Mobile Radio (LMR) system for communication between workers, thereby allowing a company to bridge the gap that occurs through the process of digitally transforming their systems. Communication can thus be more open because legacy systems and modern apparatuses communicate with fewer barriers, the communication range is not limited by the radio infrastructure due to the Internet capabilities of the mobile radio devices, and costs are reduced for a company to provide communication apparatuses to their workforce by obviating more-expensive, legacy radios. Moreover, the mobile radio devices provide workers with increased communication capability to improve workforce accessibility and can be adapted to in-field working conditions. As a result, workers in the field can use the mobile radio devices to stay connected with other team members located on or off site, thereby increasing productivity by limiting the need for workers to carry additional, distracting devices on site or leave the site entirely.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

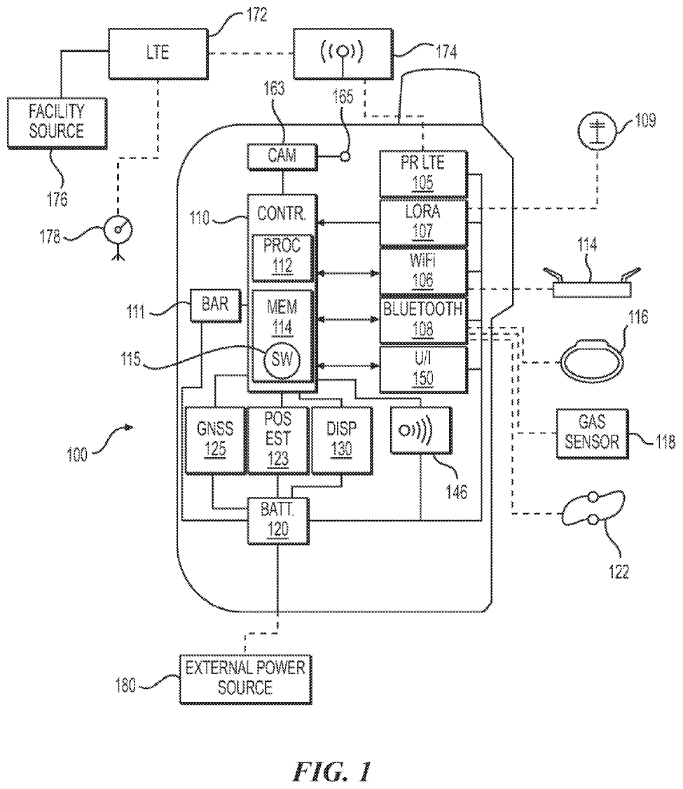

FIG. 1 is a block diagram illustrating an example architecture for an apparatus 100 with conferencing capability, in accordance with one or more embodiments. The portable wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which in embodiments, is a Global Navigation Satellite System (GNSS) component. A battery 120 is electrically coupled with a private Long-Term Evolution (LTE) cellular subsystem 105, a Wi-Fi subsystem 106, a low-power wide area network (LPWAN) (e.g., long range (LoRa) protocol subsystem 107), Bluetooth subsystem 108, barometer 111, audio device 140, user input device 150, and built-in camera 160 for providing electrical power.

The battery 120 can be electrically and communicatively coupled with controller 110 for providing electrical power to controller 110 and to enable the controller 110 to determine a status of battery 120 (e.g., a state-of-charge). In embodiments, battery 120 is a non-removable rechargeable battery (e.g., using the external power source 180). In this way, the battery 120 cannot be removed by a worker to power down the apparatus 100, or subsystems of the apparatus 100 (e.g., position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

Controller 110 is, for example, a computer having a memory 114, including a non-transitory storage medium for storing software 115, and a processor 112 for executing instructions of the software 115. In some embodiments, controller 110 is a microcontroller, a microprocessor, an integrated circuit (IC), or a system-on-a-chip (SoC). Controller 110 can include at least one clock capable of providing time stamps or displaying time via display 130. The at least one clock can be updatable (e.g., via the user input device 150, a global positioning system (GPS) navigational device, the position tracking component 125, the Internet, a private cellular network subsystem, the server 170, or a combination thereof).

The wireless communications arrangement can include a cellular subsystem 105, a Wi-Fi subsystem 106, LPWAN/LoRa protocol subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

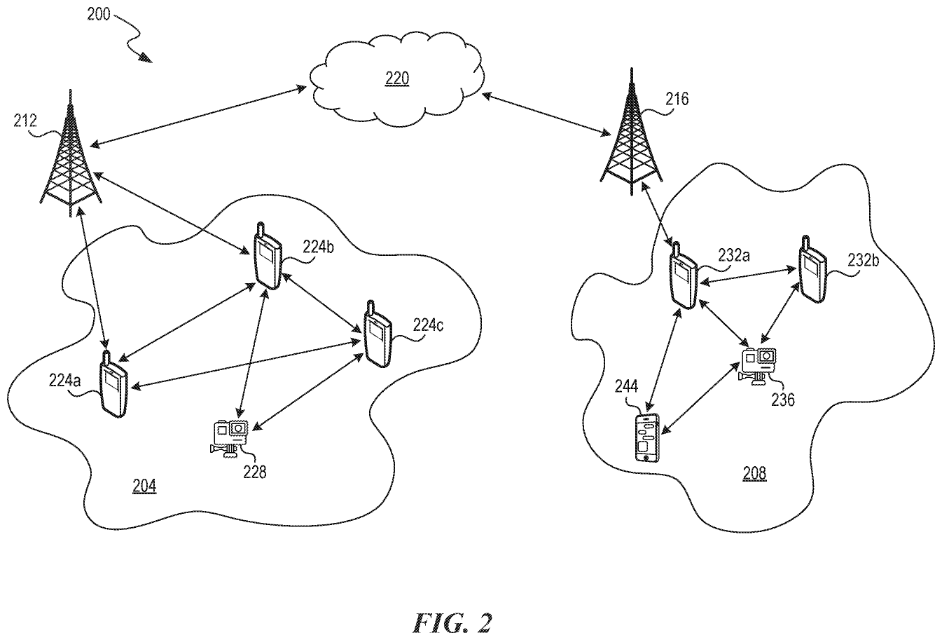

In embodiments, a cellular edge router arrangement 172 is provided for implementing a common wireless source. A cellular edge router arrangement (sometimes referred to as an “edge kit 172”) can provide a wireless connection to the Internet. In embodiments, the LPWAN network 109, the wireless cellular network, or a local radio network is implemented as a local network for the facility usable by instances of the apparatus 100 (e.g., local network 204 illustrated in FIG. 2). For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

A Wi-Fi subsystem 106 enables the apparatus 100 to communicate with an access point capable of transmitting and receiving data wirelessly in a relatively high-frequency band. In embodiments, the Wi-Fi subsystem 106 is also used in testing the apparatus 100 prior to deployment. A Bluetooth subsystem 108 enables the apparatus 100 to communicate with a variety of peripheral devices, including a biometric interface device 116 and a gas/chemical detection device 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the cloud/Internet for accessing websites, databases, etc. For example, the apparatus 100 can be capable of connecting with a conference call or video conference at a remote conferencing server. The apparatus 100 can interface with a conferencing software (e.g., Microsoft Teams™, Skype™, Zoom™, Cisco Webex™. The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The position tracking component 125 and the position estimating component 123 operate in concert. In embodiments, the position tracking component 125 is a GNSS (e.g., GPS) navigational device that receives information from satellites and determines a geographical position based on the received information. The position tracking component 125 is used to track the location of the apparatus 100. In embodiments, a geographic position is determined at regular intervals (e.g., every five seconds) and the position in between readings is estimated using the position estimating component 123.

GPS position data is stored in memory 114 and uploaded to server 170 at regular intervals (e.g., every minute). In embodiments, the intervals for recording and uploading GPS data are configurable. For example, if the apparatus 100 is stationary for a predetermined duration, the intervals are ignored or extended, and new location information is not stored or uploaded. If no connectivity exists for wirelessly communicating with server 170, location data is stored in memory 114 until connectivity is restored, at which time the data is uploaded, then deleted from memory 114. In embodiments, GPS data is used to determine latitude, longitude, altitude, speed, heading, and Greenwich Mean Time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer component is used to determine a height at which the apparatus 100 is located (or operate in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, display 130 is a touch screen implemented using a liquid-crystal display (LCD), an e-ink display, an organic light-emitting diode (OLED), or other digital display capable of displaying text and images. In embodiments, display 130 uses a low-power display technology, such as an e-ink display, for reduced power consumption. Images displayed using display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log into a profile (e.g., stored at a remote server) on the apparatus 100 through his or her worker ID badge. The worker's profile may store information related to the workers. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs into the apparatus 100, however, that user can now be associated with the apparatus 100.

### Communication Network Features

FIG. 2 is a drawing illustrating an example environment 200 for apparatuses and communication networks with conferencing capability, in accordance with one or more embodiments. The environment 200 includes a cloud computing system 220, cellular transmission towers 212, 216, and local networks 204, 208. Components of the environment 200 are implemented using components of the example computer system illustrated and described in more detail with reference to subsequent figures. Likewise, different embodiments of the apparatus 100 include different and/or additional components and are connected in different ways.

Smart radios 224, 232 and smart cameras 228, 236 are implemented in accordance with the architecture shown by FIG. 1. In embodiments, smart sensors implemented in accordance with the architecture shown by FIG. 1 are also connected to the local networks 204, 208 and mounted on a surface of a worksite or worn or carried by workers. For example, the local network 204 is located at a first facility and the local network 208 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 224a to connect to the local (e.g., cellular) network 204 and a second SIM card enables the smart radio 224a to connect to a commercial cellular tower (e.g., cellular tower 212) for access to mobile telephony, the Internet, and the cloud computing system 220 (e.g., to major participating networks such as Verizon™, AT&T™, T-Mobile™, or Sprint™). In such embodiments, the smart radio 224a has two radio transceivers, one for each SIM card. In other embodiments, the smart radio 224a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM becomes inactive until the first SIM card is no longer actively used.

In embodiments, the local network 204 uses a private address space of IP addresses. In other embodiments, the local network 204 is a local radio-based network using peer-to-peer two-way radio (duplex communication) with extended range based on hops (e.g., from smart radio 224a to smart radio 224b to smart radio 224c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 204 to serve a facility. The smart apparatuses serve as multiple transmit/receive sites interconnected to achieve the range of coverage required by the facility. Further, the signals on the local networks 204, 208 are backhauled to a central switch for communication to the cellular transmission towers 212, 216.

In embodiments (e.g., in more remote locations), the local network 204 is implemented by sending radio signals between smart radios 224. Such embodiments are implemented in less inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 224a to other smart radios 224b, 224c on one or more frequency channels operating as a two-way radio. The radio messages sent include a header and a payload. Such broadcasting does not require a session or a connection between the devices. Data in the header is used by a receiving smart radio 224b to direct the “packet” to a destination (e.g., smart radio 224c). At the destination, the payload is extracted and played back by the smart radio 224c via the radio's speaker.

For example, the smart radio 224a broadcasts voice data using radio signals. Any other smart radio 224b within a range limit (e.g., 1 mile (mi), 2 mi, etc.) receives the radio signals. The radio data includes a header having the destination of the message (smart radio 224c). The radio message is decrypted/decoded and played back on only the destination smart radio 224c. If another smart radio 224b receives the radio signals but was not the destination radio, the smart radio 224b rebroadcasts the radio signals rather than decoding and playing them back on a speaker. The smart radios 224 are thus used as signal repeaters. The advantages and benefits of the embodiments disclosed herein include extending the range of two-way radios or smart radios 224 by implementing radio hopping between the radios.

In embodiments, the local network 204 is implemented using Citizens Broadband Radio Service (CBRS). The use of CBRS Band 48 (from 3550 MHz to 3700 MHz), in embodiments provides numerous advantages. For example, the use of Band 48 provides longer signal ranges and smoother handovers. The use of CBRS Band 48 supports numerous smart radios 224 and smart camera 228 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 204 is a private cellular (e.g., LTE) network operated specifically for the benefit of the facility. Only authorized users of the smart radios 224 have access to the local network 204. For example, the network 204 uses the 900 MHz spectrum. In another example, the local network 204 uses 900 MHz for voice and narrowband data for LMR communications, 900 MHz broadband for critical wide area, long-range data communications, and CBRS for ultra-fast coverage of smaller areas of the facility, such as substations, storage yards, and office spaces.

The smart radios 224 can communicate using other communication technologies, for example, Voice over IP (VoIP), Voice over WiFi (VoWIFI), or Voice over Long-Term Evolution (VoLTE). The smart radios 224 can connect to a communication session (e.g., voice call, video call) for real-time communication with specific devices. The communications sessions can include devices within or outside of the local network 204 (e.g., in the local network 208). The communication sessions can be hosted on a private server (e.g., of the local network 204) or a remote server (e.g., accessible through the cloud computing system 220). In other aspects, the session can be peer-to-peer (P2P).

The cloud computing system 220 delivers computing services—including servers, storage, databases, networking, software, analytics, and intelligence—over the Internet (“the cloud”) to offer faster innovation, flexible resources, and economies of scale. FIG. 2 depicts an exemplary high-level, cloud-centered network environment 200 otherwise known as a cloud-based system. Referring to FIG. 2, it can be seen that the environment centers around the cloud computing system 220 and the local networks 204, 208. Through the cloud computing system 220, multiple software systems are made to be accessible by multiple smart radios 224, 232, smart cameras 228, 236, as well as more standard devices (e.g., a smartphone 244 or a tablet) each equipped with local networking and cellular wireless capabilities. Each of the apparatuses 224, 228, 244, although diverse, can embody the architecture of apparatus 100 shown by FIG. 1, but are distributed to different kinds of users or mounted on surfaces of the facility. For example, the smart radio 224a is worn by employees or independently contracted workers at a facility. The CBRS-equipped smartphone 244 is utilized by an on or offsite supervisor. The smart camera 228 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 224, 232, smart cameras 228, 236, smartphone 244).

In embodiments, the cloud computing system 220 and local networks 204, 208 are configured to send communications to the smart radios 224, 232 or smart cameras 228, 236 based on analysis conducted by the cloud computing system 220. The communications enable the smart radio 224 or smart camera 228 to receive warnings, etc., generated as a result of analysis conducted. The employee-worn smart radio 224a (and possibly other devices including the architecture of apparatus 100, such as the smart cameras 228, 236) are used along with the peripherals shown in FIG. 1 to accomplish a variety of objectives. For example, workers, in embodiments, are equipped with a Bluetooth enabled gas-detection smart sensor. The smart sensor detects the existence of a dangerous gas or gas level. By connecting through the smart radio 224a or directly to the local network 204, the readings from the smart sensor are analyzed by the cloud computing system 220 to implement a course of action due to sensed characteristics of toxicity. The cloud computing system 220 sends an alert out to the smart radio 224 or smart camera 228, and thus a worker, for example, uses a speaker or alternative notification means to alert the worker so that he or she can avoid danger.

### Example Facility

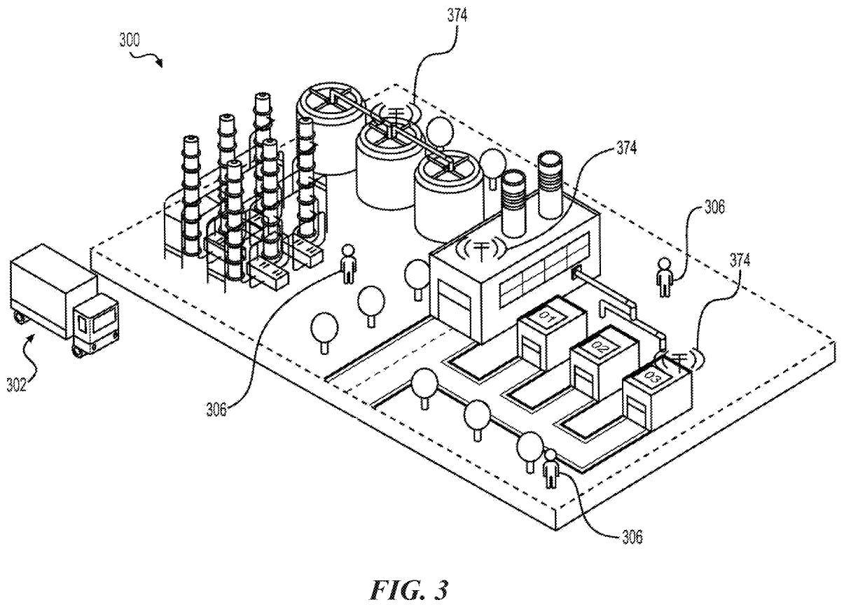

FIG. 3 is a drawing illustrating an example facility 300 using apparatuses and communication networks with conferencing capability, in accordance with one or more embodiments. For example, the facility 300 is a refinery, a manufacturing facility, a construction site, etc. The communication technology shown by FIG. 3 can be implemented using components of the example computer systems illustrated and described in more detail with reference to the other figures herein.

Multiple differently and strategically placed wireless antennas 374 are used to receive signals from an Internet source (e.g., a fiber backhaul at the facility), or a mobile system (e.g., a truck 302). The truck 302, in embodiments, can implement an edge kit used to connect to the Internet. The strategically placed wireless antennas 374 repeat the signals received and sent from the edge kit such that a private cellular network is made available to multiple workers 306. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 3 shows that multiple wireless antennas 374 are installed at various locations throughout the facility. Where the edge kit is located at a location near a facility fiber backhaul, the communication system in the facility 300 uses multiple omnidirectional Multi-Band Outdoor (MBO) antennas as shown. Where the Internet source is instead located near an edge of the facility 300, as is often the case, the communication system uses one or more directional wireless antennas to improve the coverage in terms of bandwidth. Alternatively, where the edge kit is in a mobile vehicle, for example, truck 302, the antennas' directional configuration would be picked depending on whether the vehicle would ultimately be located at a central or boundary location.

In embodiments where a backhaul arrangement is installed at the facility 300, the edge kit is directly connected to an existing fiber router, cable router, or any other source of Internet at the facility. In embodiments, the wireless antennas 374 are deployed at a location in which the smart radio is to be used. For example, the wireless antennas 374 are omnidirectional, directional, or semi-directional depending on the intended coverage area. In embodiments, the wireless antennas 374 support a local cellular network. In embodiments, the local network is a private LTE network (e.g., based on 4G or 5G). In more specific embodiments, the network is a Band 48 CBRS local network. The frequency range for Band 48 extends from 3550 MHz to 3700 MHz and is executed using TDD as the duplex mode. The private LTE wireless communication device is configured to operate in the private network created, for example, configured to accommodate Band 48 CBRS in the frequency range for Band 48 (again, from 3550 MHz to 3700 MHz) and accommodates TDD. Thus, channels within the preferred range are used for different types of communications between the cloud and the local network.

### ML System

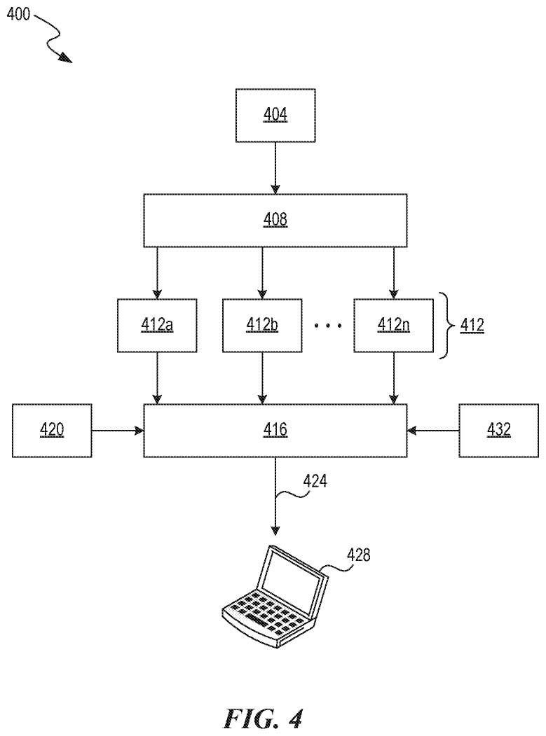

FIG. 4 is a block diagram illustrating an example ML system 400, in accordance with one or more embodiments. The ML system 400 can implement one or more components of the computer systems and apparatuses discussed herein. Although illustrated in a particular configuration, different embodiments of the ML system 400 include different and/or additional components and are connected in different ways. The ML system 400 is sometimes referred to as an ML module.

The ML system 400 includes a feature extraction module 408 implemented using components of an example computer system, as described herein. In some embodiments, the feature extraction module 408 extracts a feature vector 412 from input data 404. The feature vector 412 includes features 412a, 412b, . . . , 412n. The feature extraction module 408 reduces the redundancy in the input data 404, for example, repetitive data values, to transform the input data 404 into the reduced set of feature vectors 412, for example, features 412a, 412b, . . . , 412n. The feature vector 412 contains the relevant information from the input data 404, such that events or data value thresholds of interest are identified by the ML model 416 by using a reduced representation. In some example embodiments, the following dimensionality reduction techniques are used by the feature extraction module 408: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 416 performs deep learning (also known as deep structured learning or hierarchical learning) directly on the input data 404 to learn data representations, as opposed to using task-specific algorithms. In deep learning, no explicit feature extraction is performed; the feature vectors 412 are implicitly extracted by the ML system 400. For example, the ML model 416 uses a cascade of multiple layers of nonlinear processing units for implicit feature extraction and transformation. Each successive layer uses the output from the previous layer as input. The ML model 416 thus learns in supervised (e.g., classification) and/or unsupervised (e.g., pattern analysis) modes. The ML model 416 learns multiple levels of representations that correspond to different levels of abstraction, wherein the different levels form a hierarchy of concepts. The multiple levels of representation configure the ML model 416 to differentiate features of interest from background features.

In alternative example embodiments, the ML model 416, for example, in the form of a CNN generates the output 424, without the need for feature extraction, directly from the input data 404. The output 424 is provided to the computer device 428. The computer device 428 is a server, computer, tablet, smartphone, smart speaker, etc., implemented using components of an example computer system, as described herein. In some embodiments, the steps performed by the ML system 400 are stored in memory on the computer device 428 for execution. In other embodiments, the output 424 is displayed on an apparatus or electronic displays of a cloud computing system.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 416 is a CNN that includes both convolutional layers and max pooling layers. For example, the architecture of the ML model 416 is “fully convolutional,” which means that variable sized sensor data vectors are fed into it. For convolutional layers, the ML model 416 specifies a kernel size, a stride of the convolution, and an amount of zero padding applied to the input of that layer. For the pooling layers, the model 416 specifies the kernel size and stride of the pooling.

In some embodiments, the ML system 400 trains the ML model 416, based on the training data 420, to correlate the feature vector 412 to expected outputs in the training data 420. As part of the training of the ML model 416, the ML system 400 forms a training set of features and training labels by identifying a positive training set of features that have been determined to have a desired property in question, and, in some embodiments, forms a negative training set of features that lack the property in question.

The ML system 400 applies ML techniques to train the ML model 416 that, when applied to the feature vector 412, output indications of whether the feature vector 412 has an associated desired property or properties, such as a probability that the feature vector 412 has a particular Boolean property or an estimated value of a scalar property. In embodiments, the ML system 400 further applies dimensionality reduction (e.g., via linear discriminant analysis (LDA), PCA, or the like) to reduce the amount of data in the feature vector 412 to a smaller, more representative set of data.

In embodiments, the ML system 400 uses supervised ML to train the ML model 416, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 432 is formed of additional features, other than those in the training data 420, which have already been determined to have or to lack the property in question. The ML system 400 applies the trained ML model 416 to the features of the validation set 432 to quantify the accuracy of the ML model 416. Common metrics applied in accuracy measurement include Precision and Recall, where Precision refers to a number of results the ML model 416 correctly predicted out of the total it predicted, and Recall is a number of results the ML model 416 correctly predicted out of the total number of features that had the desired property in question. In some embodiments, the ML system 400 iteratively retrains the ML model 416 until the occurrence of a stopping condition, such as the accuracy measurement indication that the ML model 416 is sufficiently accurate, or a number of training rounds having taken place. In embodiments, the validation set 432 includes data corresponding to confirmed locations, dates, times, activities, or combinations thereof. This allows the detected values to be validated using the validation set 432. The validation set 432 is generated based on the analysis to be performed.

### Computing System

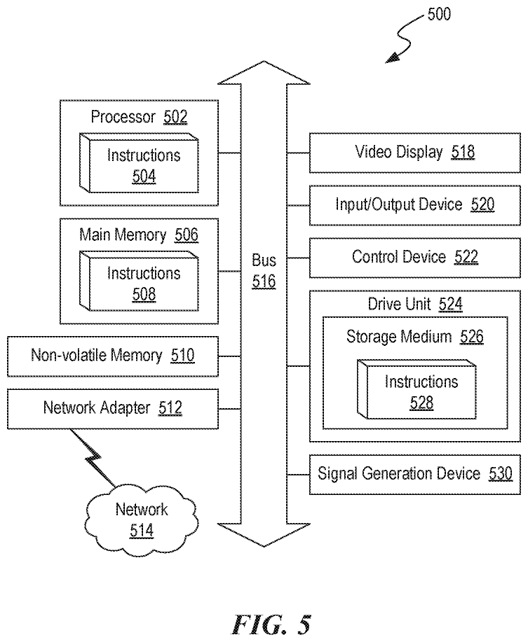

FIG. 5 is a block diagram illustrating an example computer system 500, in accordance with one or more embodiments. At least some operations described herein are implemented on the computer system 500. The computer system 500 includes one or more central processing units (“processors”) 502, main memory 506, non-volatile memory 510, network adapters 512 (e.g., network interface), video displays 518, input/output devices 520, control devices 522 (e.g., keyboard and pointing devices), drive units 524 including a storage medium 526, and a signal generation device 530 that are communicatively connected to a bus 516. The bus 516 is illustrated as an abstraction that represents one or more physical buses and/or point-to-point connections that are connected by appropriate bridges, adapters, or controllers. In embodiments, the bus 516 includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an IEEE standard 1394 bus (also referred to as “Firewire”).

In embodiments, the computer system 500 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 500.

While the main memory 506, non-volatile memory 510, and storage medium 526 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 528. The term “machine-readable medium” and “storage medium” shall also be taken to include any medium that is capable of storing, encoding, or carrying a set of instructions for execution by the computer system 500.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 504, 508, 528) set at various times in various memory and storage devices in a computer device. When read and executed by the one or more processors 502, the instruction(s) cause the computer system 500 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 510, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 512 enables the computer system 500 to mediate data in a network 514 with an entity that is external to the computer system 500 through any communication protocol supported by the computer system 500 and the external entity. In embodiments, the network adapter 512 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 512 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

### Conferencing with Mobile Radio Devices

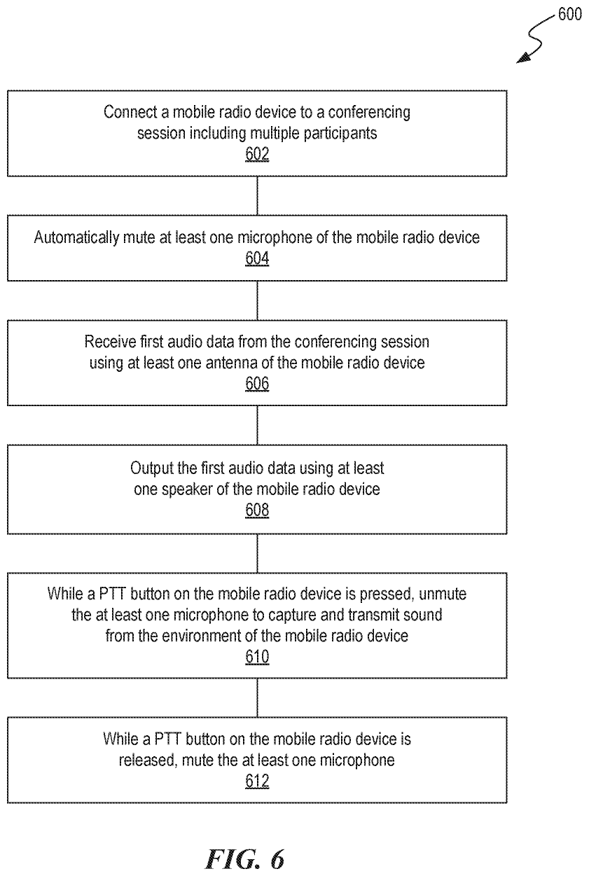

FIG. 6 illustrates a method 600 for conferencing with a mobile radio device, in accordance with one or more embodiments. In contrast to other mobile radio devices, the mobile radio devices discussed herein can connect to conferencing sessions, for example, meetings with supervisors located off worksite. The conferences can facilitate communication between mobile radio devices, utilized by workers at the worksite, and wireless devices (e.g., smartphones, tablets, laptops), utilized by office staff. Accordingly, the mobile radio devices can be used to improve communication flexibility by enabling additional forms of communication across various devices.

At 602, a mobile radio device is connected to a conferencing session (e.g., conference calls or video conferences provided by conferencing software). The conference sessions can include devices within or outside of a local network (e.g., the local network 204 of FIG. 2). For example, a conference may include one or more of the computing devices (e.g., smartphones, laptops, tablets) and one or more of the mobile radio devices. The conference can be hosted on a private server (e.g., of the local network 204 of FIG. 2) or a remote server (e.g., accessible through a cloud computing system). In other aspects, the conference session can be a peer-to-peer (P2P) conference.

The mobile radio device can communicate using VoIP, VoWIFI, or VoLTE. The mobile radio device can connect to a communication session for real-time communication with specific devices. In some cases, the mobile radio devices can communicate using RoIP. In RoIP, radio waves can be converted into packets sent over an IP framework. The mobile radio devices can include their own IP end point, or they can communicate via radio waves with an IP endpoint located nearby (e.g., at the facility 300 of FIG. 3).

At 604, at least one microphone of the mobile radio device is automatically muted upon connecting to the conferencing session. In aspects, communication sessions can be augmented with PTT. For example, the mobile radio devices have a PTT button (e.g., dedicated button) on a user interface. In this way, a user has to press the PTT button to unmute the microphone and enable audio data to be transmitted through the communication session. The mobile radio device can be muted by default such that audio received through a microphone of the mobile radio device is only transmitted when the PTT button is pressed.

At 606, the mobile radio device receives first audio data from the video conferencing session using at least one antenna of the mobile radio device. The audio data can be transmitted from one of the other devices connected to the audio session. The mobile radio device can receive the audio data through any appropriate wireless technology. In aspects, the mobile radio device only receives audio data when the PTT button is released (e.g., half duplex communication). In this way, the PTT button can control the transmit/receive functionality of the mobile radio device or the antenna.

At 608, the mobile radio device outputs the first audio data using at least one speaker of the mobile radio device. The volume of the first audio data can be controlled by a user of the mobile radio device. In aspects, the first audio data is only output when the PTT button is released. This can be the case even when the audio data has already been received by the mobile radio device. In other cases, the PTT button controls the reception of the audio data. Thus, when the PTT button is pressed, the audio data is not received and, as a result, not output. In these ways, the PTT button can control the output of audio data from the conferencing session. In other cases, the audio data can be received or output regardless of the state (e.g., pressed or released) of the PTT button. For example, the mobile radio device can receive audio data and transmit audio data through the conferencing session at a same time (e.g., while the PTT button is pressed).

The mobile radio device can also receive video data through the conferencing session (e.g., from a conferencing server). For example, the mobile radio device can display, on a display of the mobile radio device, video data received from a camera of one or more devices connected to the conferencing session. The reception of the video data can be independent of the state of the PTT button. For example, the mobile radio device can continue to receive video data even when the PTT button is pressed. In this way, the PTT button can mute and unmute the mobile radio device without affecting the video. In other cases, the reception of the video data can be based on the state of the PTT button. For example, the mobile radio device can transmit video data when the PTT button is pressed and receive video data when the PTT button is released.

At 610, and while the PTT is pressed, the microphone is unmuted and second audio data from an environment of the mobile radio device (e.g., user speech) can be captured by the microphone and transmitted through the conferencing session (e.g., to a conferencing server hosting the conference). The second audio data can be generated by the mobile radio device from sounds collected from the environment of the mobile radio device by the microphone. In some cases, the mobile radio device can only receive audio through the microphone when the PTT button is pressed. In other cases, the mobile radio device can receive audio through the microphone without control by the PTT button, however, the audio is not processed into audio data (e.g., packets are not generated) or transmitted through the conferencing session unless the PTT button is pressed.

The mobile radio device can also transmit video data through the conferencing session (e.g., to a conferencing server). For example, the mobile radio device can collect video data and transmit the data through the conferencing session such that the video data can be received by the other devices connected to the conferencing session. The transmission of the video data can be independent of the state of the PTT button. For example, the mobile radio device can continue to transmit video data even when the PTT button is released. In this way, the PTT button can mute and unmute the mobile radio device without affecting the video. In other cases, the transmission of the video data can be based on the state of the PTT button. For example, the mobile radio device can record or transmit video data only when the PTT button is pressed.

At 612, and while the PTT button is released, the mobile radio device is muted. In aspects, release of the PTT button returns the mobile radio device back to the default, muted state. The mobile radio device can be muted at the microphone, preventing the microphone from collecting sound from the environment of the mobile radio device, or by turning off a transmitter of the mobile radio device, preventing collected audio from being transmitted through the conferencing session. In doing so, audio data is only transmitted when the user intends to talk, thereby reducing background noise in conferencing sessions, which can be a particular problem when conferencing sessions are joined from noisy worksites.

The mobile radio device can further interact with a conferencing session through a user input system on the mobile radio device. For example, the mobile radio device may display information related to the conferencing session (e.g., conference participants, chat room, meeting length). A user can navigate the information related to the conferencing session through the user input system on the mobile radio device. Moreover, the user can interact with elements of the conferencing session through the user input system. For example, the user can type in a chat room of the conferencing session, mute other users, or record the conferencing session using the user interface.

### User Interface

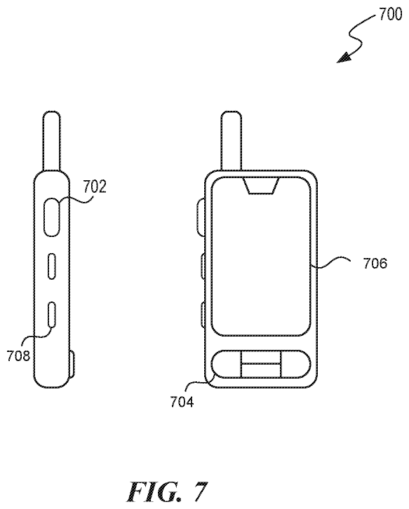

FIG. 7 illustrates an example mobile radio device 700 with conferencing capability, in accordance with one or more embodiments. The mobile radio device 700 includes a PTT button 702, a 4-button user input system 704, a display 706, and an easy to grab volume control 708 that can be used to increase or decrease the volume of the device 700. The PTT button 702 can be used to control the transmission of data from or the reception of data by the mobile radio device 700. For example, the mobile radio device 700 may transmit audio data when the PTT button 702 is pressed and receive audio data when the PTT button 702 is released. In other examples, the PTT button 702 may control the transmission of audio data from the mobile radio device 700 (e.g., transmit when the PTT button 702 is pressed), though the mobile radio device 700 may transmit and receive audio data at the same time (e.g., full duplex communication). The 4-button user input system 704 can be used to interact with the mobile radio device 700. For example, the 4-button user input system 704 can be used as a 4-direction input system (e.g., up-down-left-right), a 2-directional-enter-back (e.g., up-down-enter-back), or any other button configuration. The display 706 can output relevant visual information to the user. The volume control 708 can control the loudness of the mobile radio device 700.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A mobile radio device comprising:
a housing including a Push-to-Talk (PTT) button;
at least one display device;
at least one antenna;
at least one microphone;
at least one speaker;
at least one processor; and
one or more non-transitory, computer-readable storage mediums that includes machine-readable instructions that, when executed by the at least one processor, cause the mobile device radio to:
connect to a video conferencing session including multiple participants;
in response to connecting to the video conferencing session, automatically mute the at least one microphone;
receive, through the video conferencing session and using the at least one antenna, first audio data and first video data from another device of the multiple participants connected to the video conferencing session;
in response to receiving the first audio data and the first video data, output, using the at least one display device and the at least one speaker, the first audio data and the first video data received through the video conferencing session;
detect that the PTT button is pressed;
in response to detecting that the PTT button is pressed, unmute the at least one microphone while the PTT button is pressed;
capture, while the PTT button is pressed and using the at least one microphone, sound from an environment of the mobile radio device;
generate second audio data based on the sound captured using the at least one microphone;
transmit, through the video conferencing session and using the at least one antenna, the second audio data generated by the mobile radio device;
detect that the PTT button is released; and
in response to detecting that the PPT button is released, mute the at least one microphone by default while the mobile radio device is connected to the video conferencing session.

2. The mobile radio device of claim 1, wherein the mobile radio device is further caused to output the first audio data only while the PPT button is released.

3. The mobile radio device of claim 1, wherein the mobile radio device is further caused to output the first audio data regardless of whether the PPT button is pressed or released.

4. The mobile radio device of claim 1, wherein the mobile radio device is further caused to output the first video data regardless of whether the PPT button is pressed or released.

5. The mobile radio device of claim 1, further comprising at least one optical sensor, wherein the mobile radio device is further caused to:
capture, using the at least one optical sensor, one or more image frames from the environment of the mobile radio device;
generate, based on the one or more image frames from the environment of the mobile radio device, second video data; and
transmit, through the video conferencing session and using the at least one antenna, the second video data generated by the mobile radio device.

6. The mobile radio device of claim 4, wherein the mobile radio device is further caused to transmit the second video data generated by the mobile radio device only while the PPT button is pressed.

7. The mobile radio device of claim 4, wherein the mobile radio device is further caused to transmit the second video data generated by the mobile radio device regardless of whether the PPT button is pressed or released.

8. The mobile radio device of claim 1, wherein the mobile radio device is further caused to:
receive, through the video conferencing session and using the at least one antenna, data indicative of an identity of the multiple participants of the video conferencing session, a chat room of the video conferencing session, or a meeting length of the video conferencing session; and
output, using the at least one display device, the data indicative of the identity of the multiple participants of the video conferencing session, the chat room of the video conferencing session, or the meeting length of the video conferencing session.

9. A method comprising:
connecting a mobile radio device to a video conferencing session including multiple participants;
in response to connecting to the video conferencing session, automatically muting at least one microphone of the mobile radio device;
receiving, through the video conferencing session and using at least one antenna of the mobile radio device, first audio data and first video data from another device of the multiple participants connected to the video conferencing session;
in response to receiving the first audio data and the first video data, outputting, using at least one display device of the mobile radio device and at least one speaker of the mobile radio device, the first audio data and the first video data received through the video conferencing session;
detecting that a Push-to-Talk (PTT) button of the mobile radio device is pressed;
in response to detecting that the PTT button is pressed, unmuting the at least one microphone while the PTT button is pressed;
capturing, while the PTT button is pressed and using the at least one microphone, sound from an environment of the mobile radio device;
generating second audio data based on the sound captured using the at least one microphone;
transmitting, through the video conferencing session and using the at least one antenna, the second audio data;
detecting that the PTT button is released; and
in response to detecting that the PPT button is released, muting the at least one microphone by default while the mobile radio device is connected to the video conferencing session.

10. The method of claim 9, wherein the first audio data is output only while the PPT button is released.

11. The method of claim 9, wherein the first audio data is output regardless of whether the PPT button is pressed or released.

12. The method of claim 9, wherein the first video data is output regardless of whether the PPT button is pressed or released.

13. The method of claim 9, further comprising:
capturing, using at least one optical sensor of the mobile radio device, one or more image frames from the environment of the mobile radio device;
generating, based on the one or more image frames from the environment of the mobile radio device, second video data; and
transmitting, through the video conferencing session and using the at least one antenna, the second video data.

14. The method of claim 13, wherein second video data is transmitted only while the PPT button is pressed.

15. The method of claim 13, wherein the second video data is transmitted regardless of whether the PPT button is pressed or released.

16. The method of claim 13, further comprising:
receiving, through the video conferencing session and using the at least one antenna, data indicative of an identity of the multiple participants of the video conferencing session, a chat room of the video conferencing session, or a meeting length of the video conferencing session; and
outputting, using the at least one display device, the data indicative of the identity of the multiple participants of the video conferencing session, the chat room of the video conferencing session, or the meeting length of the video conferencing session.

17. The method of claim 9, wherein the video conferencing session is hosted on a remote conferencing server.

18. A mobile radio device comprising:
a housing including a Push-to-Talk (PTT) button;
at least one antenna;
at least one microphone;
at least one speaker;
at least one processor; and
one or more non-transitory, computer-readable storage mediums that include machine-readable instructions that, when executed by the at least one processor, cause the mobile device radio to:
connect to a conferencing session including multiple participants;
in response to connecting to the conferencing session, automatically mute the at least one microphone;
receive, through the conferencing session and using the at least one antenna, first audio data from another device of the multiple participants connected to the conferencing session;
in response to receiving the first audio data, output, using the at least one speaker, the first audio data received through the conferencing session;
detect that the PTT button is pressed;
in response to detecting that the PTT button is pressed, unmute the at least one microphone while the PTT button is pressed;
capture, while the PTT button is pressed and using the at least one microphone, sound from an environment of the mobile radio device;
generate second audio data based on the sound captured using the at least one microphone;
transmit, through the conferencing session and using the at least one antenna, the second audio data generated by the mobile radio device;
detect that the PTT button is released; and
in response to detecting that the PPT button is released, mute the at least one microphone by default while the mobile radio device is connected to the conferencing session.

19. The mobile radio device of claim 18, wherein the mobile radio device is further caused to output the first audio data only while the PPT button is released.

20. The mobile radio device of claim 18, wherein the mobile radio device is further caused to output the first audio data regardless of whether the PPT button is pressed or released.
